(19) United States
(12) Patent Application Publication
(10) Pub. No.: US 2026/0228671 A1
(43) Pub. Date: Aug. 6, 2026

(54) METHOD AND DEVICE FOR PROVIDING PERSONNEL EVALUATION MANAGEMENT SERVICE SYNCHRONIZED IN ASSOCIATION WITH COLLABORATION TOOL

(71) Applicant: INNOBROWN INC., Seoul (KR)

(72) Inventor: Hee Cherl CHAE, Goyang-si (KR)

(73) Assignee: INNOBROWN INC., Seoul (KR)

(21) Appl. No.: 19/151,798

(22) PCT Filed: Nov. 17, 2023
(86) PCT No.: PCT/KR2023/018504

§ 371 Date: Jul. 29, 2025

(30) Foreign Application Priority Data
Jan. 31, 2023 (KR) 10-2023-0012613

(51) Int. Cl. G06Q 10/0639; G06Q 10/0631; G06Q 10/101

(52) U.S. Cl. CPC G06Q 10/06398; G06Q 10/063114; G06Q 10/06393; G06Q 10/101

(57) ABSTRACT

A personnel evaluation management system that allocates key performance indicators (KPI) for responsible personnel and manages personnel evaluation by using a personnel evaluation service associated with a collaboration tool. The personnel evaluation management server may: register a first project, performed by a first company, to a collaboration tool that assists in the carrying out of at least one project; determine a first KPI list to be applied to first responsible personnel participating in the first project; receive first completion information, indicating the completion of the first project, via the collaboration tool; provide an evaluation page, display the first KPI list, to the first responsible personnel in response to the reception of the first completion information; receive first evaluation result information indicating the results of evaluations made by the responsible personnel of each other using the evaluation page; and determine personnel evaluation scores.

### TECHNICAL FIELD

The present disclosure relates generally to a personnel evaluation management system in which a synchronized personnel evaluation function is associated with a collaboration tool for proceeding with a project, and more specifically, to a device and a method for managing personnel evaluation scores for project managers using a personnel evaluation function associated with a collaboration tool.

### BACKGROUND ART

Personnel evaluation refers to a process of systematically determining a value of abilities, attitudes, and job-related performance of organizational members performing a task in a company in light of objectives. An operator of an organization uses results of the personnel evaluation as an objective basis for making decisions such as promotion and salary increase for the organizational members.

In general, the personnel evaluation is conducted by establishing a business plan every year or every quarter, assigning individual key performance indicators (KPIs) according to the business plan, and evaluating mutual performance of task managers at the end of the business execution. However, such an evaluation method has a problem in that it is difficult to ensure fairness among employees, resulting in low acceptance. In addition, it is difficult for the conventional personnel evaluation management system to reflect the evaluation results for projects that occur from time to time rather than major projects. In other words, the personnel evaluation management system often omits projects that occur from time to time, so that it is difficult to substantially reflect the degree of participation, performance support, and sincerity in the assigned task. In response to the difficulties, there is a need for technical development for personnel evaluation and multisource feedback methods that complement the disadvantages of the conventional personnel evaluation management system and are associated with all ongoing projects.

The above-described technology is technical information possessed by the present inventor for the derivation of the present invention or acquired in the derivation process of the present invention, and does not necessarily indicate a publicly known technology disclosed to the general public before the application of the present invention.

### RELATED ART DOCUMENT

[Patent Document] Korean Registered Patent No. 10-2214006 (Feb. 9, 2021)

### DISCLOSURE

### Technical Problem

Based on the above-described discussion, the present disclosure provides a device and a method for managing personnel evaluation scores by assigning a key performance indicator (KPI) to each company in consideration of a task environment of a project manager in a personnel evaluation management system.

In addition, the present disclosure provides a device and a method for assigning KPIs to task managers in consideration of KPI lists used by a plurality of companies for personnel evaluation in a personnel evaluation management system.

In addition, the present disclosure provides a device and a method for calculating a personnel evaluation score by classifying important evaluation factors in a personnel evaluation management system.

In addition, the present disclosure provides a device and a method for calculating a personnel evaluation score in consideration of an environment where a manager performs a plurality of projects.

In addition, the present disclosure provides a device and a method for providing an operator with recommended task assignment information by analyzing a case where a plurality of managers perform a plurality of projects in a personnel evaluation management system.

### Technical Solution

According to various embodiments of the present disclosure, a method for operating a personnel evaluation management server that assigns key performance indicators (KPIs) for a manager and manages personnel evaluation by using a personnel evaluation service associated with a collaboration tool, may include: registering a first project, which is performed by a first company, in a collaboration tool that assists in performing at least one project; determining a first KPI list to be applied to first managers who participate in the first project; receiving first completion information indicating the completion of the first project through the collaboration tool; providing the first managers with an evaluation page displaying the first KPI list in response to the reception of the first completion information; receiving first evaluation result information indicating the evaluation results for the managers which are made by the first managers by evaluating the first managers from each other using the evaluation page; and determining a personnel evaluation score corresponding to each of the first managers based on the first evaluation result information.

According to another embodiment, the determining of the KPI list may include: selecting a second company classified as the same industry as the first company based on a pre-stored industry classification table; extracting feature information corresponding to each of the plurality of projects performed by the second company and including factors such as a scale, a period, a region, and a difficulty level of each of a plurality of projects; extracting comparison feature information from among the feature information based on target feature information corresponding to the first project; and determining a major job KPI applied to the comparison feature information, and determining a KPI list such that KPI items included in the major job KPI are included, in which the major job KPI may indicate any one of goal achievement, growth and savings, problem solving, and human error.

According to another embodiment, the determining of the personnel evaluation score may include: receiving an importance for each factor of the important evaluation factors for the first project; determining weights for each of the KPI items based on the importance for each factor; and determining the personnel evaluation score by applying the weights to the first evaluation result information, in which the important evaluation factors may include a time factor, an achievement factor, and an error factor.

According to another embodiment, the method for operating the personnel evaluation management server may further include: determining a second KPI list to be applied to second managers who participate in the second project that is performed by the first company and registered in the collaboration tool; receiving second completion information indicating termination of execution of the second project through the collaboration tool; providing the second managers with an evaluation page that displays the second KPI list in response to reception of the second completion information; and receiving second evaluation result information indicating evaluation results for the second managers participating in the second project, which are made by the second managers by evaluating the second managers from each other, in which an execution period of the first project and an execution period of the second project at least partially overlap each other.

According to another embodiment, the method for operating the personnel evaluation management server may further include: extracting a multi-manager belonging to both the first managers and the second managers; updating an importance for each factor applied to the multi-manager by increasing an importance of the time factor for the multi-manager; and changing a personnel evaluation score for the multi-manager based on the updated importance for each factor.

According to another embodiment, the first evaluation result information may include feedback information indicating an opinion for the second task manager of the first task manager from among the first managers, and the method for operating the personnel evaluation management server may further include providing the second task manager with the feedback information.

According to another embodiment, the method for operating the personnel evaluation management server may further include: generating first analysis information indicating a change in task performance abilities of the first task manager and the second task manager when the first task manager and the second task manager from among the first managers proceed with the first project together; generating second analysis information indicating a change in a task performance ability of the first task manager when the first task manager performs the first project and a second project simultaneously; generating recommended task assignment information of the first manager based on the first analysis information and the second analysis information; and providing an operator with the personnel evaluation score and the recommended task assignment information.

Various respective aspects and features of the present invention are defined in the appended claims. Combinations of features of dependent claims may be combined with features of independent claims as appropriate, as well as being expressly set forth in the claims,

In addition, one or more features selected from any one embodiment described in the present disclosure may be combined with one or more features selected from any other embodiment described in the present disclosure, and combinations thereof are possible. An alternative combination of such features at least partially alleviates one or more technical problems discussed in the present disclosure, or at least partially alleviates technical problems discernable by those skilled in the art from the present disclosure. Furthermore, combinations are possible unless it is understood by those skilled in the art that the particular combination or permutation thus formed of the embodiment features is incompatible.

In any described example implementation described in the present disclosure, two or more physically distinct components may alternatively be integrated into a single component if the integration is possible, and the integration is possible if the same function is performed by the single component thus formed. Conversely, a single component of any embodiment described in the present disclosure may alternatively be implemented with two or more separate components that achieve the same functionality, where appropriate.

An object of certain embodiments of the present invention is to at least partially solve, mitigate, or eliminate at least one of the problems and/or disadvantages associated with the related art. Certain embodiments aim to provide at least one of the advantages described below.

### Advantageous Effects

According to the device and the method according to various embodiments of the present disclosure, it is possible to manage personnel evaluation scores by assigning a customized key performance indicator (KPI) to each company in consideration of a task environment of a project manager in the personnel evaluation management system.

In addition, according to the device and the method according to various embodiments of the present disclosure, it is possible to immediately and simply manage the personnel evaluation by adding a personnel evaluation function to a collaboration tool for organization management.

In addition, according to the device and the method according to various embodiments of the present disclosure, it is possible to precisely calculate a personnel evaluation score without omitting personnel evaluation data in consideration of an environment where one manager performs a plurality of projects in the personnel evaluation management system.

In addition, according to the device and the method according to various embodiments of the present disclosure, it is possible to precisely assign KPIs for task managers in consideration of KPI lists used for personnel evaluation of a plurality of companies in the personnel evaluation management system.

In addition, according to the device and the method according to various embodiments of the present disclosure, it is possible to precisely calculate a personnel evaluation score by classifying important evaluation factors in the personnel evaluation management system.

In addition, according to the device and the method according to various embodiments of the present disclosure, it is possible to provide an operator with recommended task assignment information by analyzing a case where a plurality of managers perform a plurality of projects in the personnel evaluation management system.

In addition, according to the device and the method according to various embodiments of the present disclosure, it is possible to reduce input of human resources for personnel evaluation operation through a synchronized personnel evaluation management service associated with a collaboration tool in the personnel evaluation management system.

The effects obtainable in the present disclosure are not limited to the effects mentioned above, and other effects not mentioned will be clearly understood by those skilled in the art to which the present disclosure pertains from the following description.

### DESCRIPTION OF DRAWINGS

The accompanying drawings, which are included as part of the detailed description to help understanding of the embodiments, provide various embodiments and describe the technical features of various embodiments together with the detailed description.

FIG. 1 illustrates a personnel evaluation management system according to various embodiments of the present disclosure.

FIG. 2 illustrates a configuration of a personnel evaluation management server in the personnel evaluation management system according to various embodiments of the present disclosure.

FIG. 3 illustrates a schematic diagram of an overall operation method of the personnel evaluation management system according to various embodiments of the present disclosure.

FIG. 4 illustrates a relationship diagram of the personnel evaluation management server, projects, and managers in the personnel evaluation management system according to various embodiments of the present disclosure.

FIG. 5 illustrates an example of a major job KPI in the personnel evaluation management system according to various embodiments of the present disclosure.

FIG. 6 illustrates an example of a UI screen displayed on a manager terminal when a manager registers a project in a collaboration tool of the personnel evaluation management server in the personnel evaluation management system according to various embodiments of the present disclosure.

FIG. 7 illustrates an example of a UI screen displayed on the manager terminal in a process of performing the project using the collaboration tool by the manager and starting a synchronized personnel evaluation management service in the personnel evaluation management system according to various embodiments of the present disclosure.

FIG. 8 illustrates an example of a UI screen displayed on the manager terminal in a process of inputting personnel evaluation by the manager in the personnel evaluation management system according to various embodiments of the present disclosure.

FIG. 9 illustrates a flowchart of a method for operating the personnel evaluation management server in the personnel evaluation management system according to various embodiments of the present disclosure,

### MODE FOR INVENTION

The terms used in the present document are used only to describe specific embodiments, and may not be intended to limit the scope of other embodiments. A singular expression may include a plural expression unless the context clearly indicates otherwise. In addition, terms used herein, including technical or scientific terms, may have the same meaning as commonly understood by one of ordinary skill in the art described in the present disclosure. Terms defined in a general dictionary among the terms used in the present disclosure may be interpreted as having the same or similar meaning as the meaning in the context of the related art, and are not interpreted in an ideal or excessively formal meaning unless explicitly defined in the present disclosure. In some cases, even terms defined in the present disclosure may not be interpreted to exclude embodiments of the present disclosure.

In various embodiments of the present disclosure described below, a hardware access method will be described as an example. However, since various embodiments of the present disclosure include a technology using both hardware and software, various embodiments of the present disclosure do not exclude a software-based access method.

Hereinafter, the present disclosure relates to a system for managing personnel evaluation of a company. Specifically, the present disclosure describes a technology for managing a personnel evaluation score by assigning a key performance indicator (KPI) to each company in consideration of a task environment of a manager who performs a task in a personnel evaluation management system.

Hereinafter, various embodiments will be described in detail with reference to the accompanying drawings so that those skilled in the art to which the present disclosure pertains may easily practice the present disclosure. However, the technical idea of the present disclosure may be modified and implemented in various forms, and thus is not limited to the embodiments described in the present specification. In describing the embodiments disclosed in the present specification, when it is determined that a detailed description of a related known technology may obscure the gist of the technical idea of the present disclosure, a detailed description of the known technology will be omitted. The same reference numerals are assigned to the same or similar components, and redundant descriptions thereof will be omitted.

In the present specification, when an element is described as being “connected” to another element, this includes not only a case of being “directly connected” but also a case of being “indirectly connected” with another element interposed therebetween. When an element “includes” another element, this means that the element may further include another element, rather than excluding another element, unless otherwise stated.

Some embodiments may be described in terms of functional block configurations and various processing steps. Some or all of these functional blocks may be implemented with various numbers of hardware and/or software configurations that execute specific functions. For example, the functional blocks of the present disclosure may be implemented by one or more microprocessors or by circuit configurations for a certain function. The functional blocks of the present disclosure may be implemented in various programming or scripting languages. The functional blocks of the present disclosure may be implemented as an algorithm executed by one or more processors. The functions performed by the functional blocks of the present disclosure may be performed by a plurality of functional blocks, or the functions performed by the plurality of functional blocks of the present disclosure may be performed by one functional block. In addition, the present disclosure may employ the related art for electronic environment setting, signal processing, and/or data processing.

In addition, in the present disclosure, in order to determine whether a specific condition is satisfied or fully filled, the expressions “more than” and “less than” are used, but this is only a description for expressing an example, and does not exclude the description “more than” and “less than”. The condition described as “equal to or more than” may be replaced with “more than”, the condition described as “equal to or less than” may be replaced with “less than”, and the condition described as “equal to or greater than and equal to or less than” may be replaced with “more than and less than”.

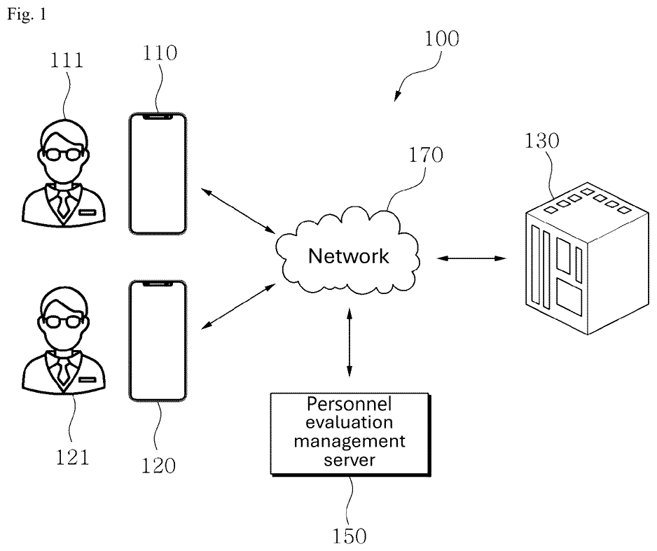

FIG. 1 illustrates a personnel evaluation management system 100 according to various embodiments of the present disclosure.

The personnel evaluation management system 100 indicates a system for managing personnel evaluation for managers who perform tasks in a company. The manager participates in a project carried out by the company and performs the task, and the executives and employees of the company evaluate various values such as the ability, project contribution, performance, and human relations of the manager of the project. The results of these evaluations can be used in various cases such as task assignment, promotion, and salary increase of the manager. According to one embodiment of the present disclosure, the personnel evaluation management system 100 may include a manager terminal 110, an operator terminal 120, an external server 130, a personnel evaluation management server 150, and a network 170.

The manager terminal 110 indicates an electronic device used by a manager 111 who performs a project of a company. In this case, the manager 111 refers to at least one executive officer or employee who performs a task, and the manager 111 may perform the project or register a progress status of the project through an application installed in the manager terminal 110. The manager terminal 110 may transmit information received from the manager 111 to another electronic device through the network 170. According to one embodiment of the present disclosure, the manager terminal 110 may include a fixed terminal or a mobile terminal implemented as a computing device. Specifically, the manager terminal 110 may indicate a smart phone, a mobile phone, a navigation device, a computer, a notebook computer, a digital broadcasting terminal, a personal digital assistant (PDA), a portable multimedia player (PMP), or a tablet personal computer (PC).

The operator terminal 120 indicates an electronic device used by an operator 121 who operates the company. The operator 121 may instruct at least one executive or employee who evaluates the result of the task, and may confirm the progress status of the project through an application installed in the operator terminal 120 and manage personnel evaluation. According to one embodiment of the present disclosure, the operator terminal 120 may also include a fixed terminal or a mobile terminal implemented as a computing device.

The external server 130 may be implemented as a computing device or a plurality of computing devices that communicate with at least one of the manager terminal 110, the operator terminal 120, and the personnel evaluation management server 150 through the network 170 to provide instructions, codes, files, contents, services, and the like. The external server 130 may store information related to personnel evaluation using a database.

The personnel evaluation management server 150 indicates an electronic device for managing personnel evaluation for managers who participate in the project of the company. The personnel evaluation management server 150 may provide a service that assists the overall organization management of the company to the company through the application. According to an example, the personnel evaluation management server 150 may assist to perform organizational tasks such as schedule management, GPS-based attendance management, and electronic approval management using a collaboration tool. In particular, the personnel evaluation management server 150 may assist the manager who participates in the project to manage personnel evaluation by using a personnel evaluation management service in association with the collaboration tool. The personnel evaluation management server 150 may associate the personnel evaluation management service with the collaboration tool for organization management to assist the manager to manage personnel evaluation in a simple manner. That is, the personnel evaluation management server 150 may provide a collaboration tool function basically necessary for performing the project to the managers, and may additionally assist the managers who have performed the project to immediately evaluate each other when the project is completed. According to one embodiment of the present disclosure, the personnel evaluation management server 150 may also be implemented as a computing device or a plurality of computing devices that provide instructions, codes, files, contents, services, and the like.

As illustrated in FIG. 1, the components of the personnel evaluation management system 100 may be connected to each other through the network 170. According to one embodiment of the present disclosure, the network 170 refers to a connection structure in which information may be exchanged between respective nodes such as a plurality of terminals and servers, and examples of the network include, but are not limited to, an RF, a 3rd generation partnership project (3GPP) network, a long term evolution (LTE) network, a 5rd generation partnership project (5GPP) network, a world interoperability for microwave access (WIMAX) network, the Internet, a local area network (LAN), a wireless local area network (Wireless LAN), a wide area network (WAN), a personal area network (PAN), a Bluetooth network, an NFC network, a satellite broadcasting network, an analog broadcasting network, a digital multimedia broadcasting (DMB) network, and the like.

According to the personnel evaluation management system 100, the personnel evaluation management server 150 may assign a customized KPI to each company in consideration of the task environment of the manager and manage the personnel evaluation score. Specifically, when a new project is registered, the personnel evaluation management server 150 may determine a KPI list in consideration of the task environment of the project. Thereafter, when the project of the company is completed, an evaluation page according to the KPI list may be provided to the managers who participate in the project, and a personnel evaluation score for each individual may be determined based on the evaluation result for the managers which are made by the managers by evaluating the managers from each other. Hereinafter, specific operations of the personnel evaluation management server 150 will be described in more detail.

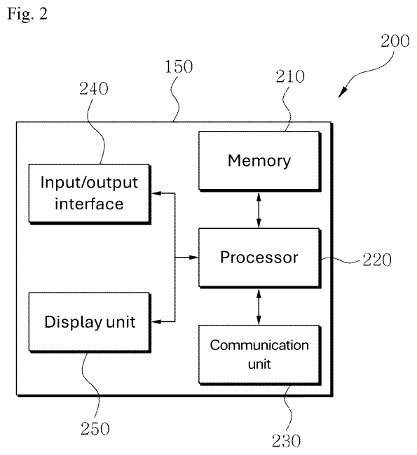

FIG. 2 illustrates a configuration 200 of the personnel evaluation management server 150 in the personnel evaluation management system 100 according to various embodiments of the present disclosure, The terms such as “. . . unit” and “ . . . er/or” used below refers to a unit for processing at least one function or operation, and may be implemented by hardware, software, or a combination of hardware and software. The personnel evaluation management server 150 may include a memory 210, a processor 220, a communication unit 230, an input/output interface 240, and a display unit 250.

The memory 210 temporarily or permanently stores data such as a basic program, an application program, and setting information for the operation of the personnel evaluation management server 150. The memory 210 may include, but is not limited to, a random access memory (RAM), a read only memory (ROM), and a permanent mass storage device such as a disk drive. The software components may be loaded from a computer-readable recording medium separate from the memory 210 using a drive mechanism. The separate computer-readable recording medium may include a computer-readable recording medium such as a floppy drive, a disk, a tape, a DVD/CD-ROM drive, a memory card, or the like. According to the embodiment, the software components may be loaded into the memory 210 through the communication unit 230 rather than the computer-readable recording medium. In addition, the memory 210 may provide data stored upon a request of the processor 220. According to one embodiment of the present disclosure, the memory 210 may store the KPI list for personnel evaluation or personnel evaluation scores.

The processor 220 controls the overall operations of the personnel evaluation management server 150. For example, the processor 220 may control signals to be transmitted and received through the communication unit 230. In addition, the processor 220 may be configured to process instructions of a computer program by performing basic arithmetic, logic, and input/output operations. The instruction may be provided to the processor 220 by the memory 210 or the communication unit 230. For example, the processor 220 may be configured to execute the received instruction according to a program code stored in a recording device such as the memory 210. For example, the processor 220 may control the personnel evaluation management server 150 to perform the operations according to various embodiments to be described below.

According to one embodiment of the present disclosure, the processor 220 may register a first project, which is performed by a first company, in a collaboration tool that assists in performing at least one project, may determine a first KPI list to be applied to first managers who participate in the first project, may receive first completion information indicating the completion of the first project through the collaboration tool, may provide the first managers with an evaluation page displaying the first KPI list in response to the reception of the first completion information, may receive first evaluation result information indicating the evaluation results for the first managers which are made by the first managers by evaluating the first managers from each other using the evaluation page, and may determine a personnel evaluation score corresponding to each of the first managers based on the first evaluation result information.

The communication unit 230 performs functions for transmitting/receiving signals through a wireless channel. All or part of the communication unit 230 may be referred to as a transmission unit, a reception unit, or a transmission/reception unit. The communication unit 230 may provide a function for the personnel evaluation management server 150 and at least one other node to communicate with each other through a communication network. According to one embodiment of the present disclosure, when the processor 220 of the personnel evaluation management server 150 generates a request signal according to the program code stored in the recording device such as the memory 210, the request signal may be transmitted to at least one other node through the communication network under the control of the communication unit 230. Conversely, a control signal, an instruction, content, a file, or the like provided under the control of the processor of at least one other node may be received by the personnel evaluation management server 150 through the communication unit 230. According to one embodiment of the present disclosure, the communication unit 230 may transmit a personnel evaluation score to at least one of the manager terminal 110 and the operator terminal 120.

The input/output interface 240 may be a unit for an interface with an input/output device (not illustrated). In this case, the input device may be provided in the form of a device such as a keyboard or a mouse, and the output device may be provided in the form of a device such as a display for displaying an image. As another example, the input/output interface 240 may be a unit for an interface with a device in which functions for input and output are integrated into one function, such as a touch screen. Specifically, the processor 220 of the personnel evaluation management server 150 may display a service screen or content, which is configured using data provided by the server, on the display through the input/output interface 240 in processing the instructions of the computer program loaded in the memory 210. According to one embodiment of the present disclosure, the input/output interface 240 may include a unit for an interface with the display unit 250. The input/output interface 240 may receive a user input to a web browsing window displayed on the display unit 250, and may receive output data to be output through the display unit 250 from the processor 220 in response to the user input described above. According to one embodiment of the present disclosure, the input/output interface 240 may receive a control signal for managing personnel evaluation of the company.

The display unit 250 indicates a display module including one or more displays. Each of the one or more displays included in the display unit 250 may individually display independent content, or the one or more displays described above may be combined to display a single content. According to one embodiment of the disclosure, the one or more displays included in the display unit 250 may include physically separated multiple displays, may be physically coupled multiple displays, or may be displays that may be used by splitting one screen. According to one embodiment of the present disclosure, the display unit 250 may display the personnel evaluation score on the display screen.

The personnel evaluation management server 150 may assign a KPI to a manager who performs a task in the company and perform personnel evaluation using the KPI. To this end, the personnel evaluation management server 150 may be equipped with a personnel evaluation management service and an insight provision function in association with the collaboration tool for organization management.

In addition, the personnel evaluation management server 150 may be equipped with a security function for a case where important files are leaked. When a file is shared through an open chat room, the personnel evaluation management server 150 may store an IP address for an account where the file has been downloaded. Thereafter, when it is determined that the data that has a security problem is shared, the personnel evaluation management server 150 may track a file sharer using the stored IP address.

In addition, the personnel evaluation management server 150 may be equipped with a personnel evaluation management function. The manager 111 or the operator 121 participating in the project may register a project to be performed in the collaboration tool of the personnel evaluation management server 150, and the personnel evaluation management server 150 may acquire information related to a task performance status of the manager 111 in the process of performing the project. Thereafter, when the project is completed, the personnel evaluation management server 150 may determine a KPI list in consideration of the task environment of the registered project and provide an evaluation page according to the KPI list to the managers participating in the project. In response to the provision, the managers who have received the evaluation page may evaluate each other using the manager terminals operated by each person and transmit the evaluation result to the personnel evaluation management server 150. The personnel evaluation management server 150 may determine a personnel evaluation score for each individual by collecting the evaluation results.

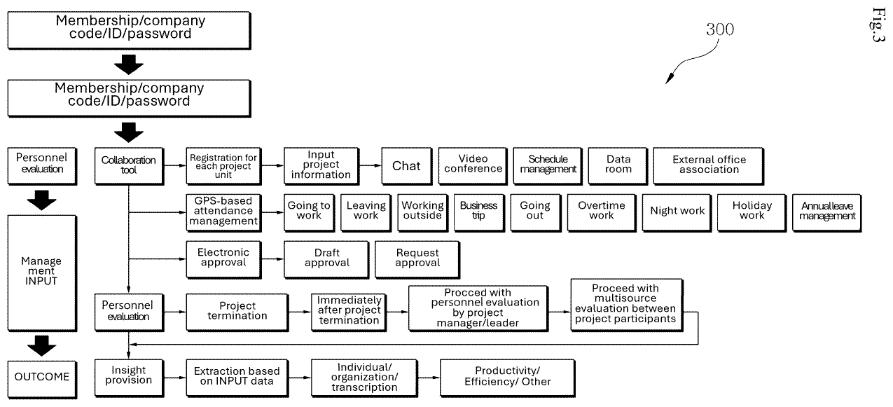

FIG. 3 illustrates a schematic diagram 300 of an overall operation method of the personnel evaluation management system 100 according to various embodiments of the present disclosure.

Referring to FIG. 3, the personnel evaluation management server 150 may indicate a device to which a synchronized personnel evaluation management service function is added to a collaboration tool that provides chat, video conference, schedule management, office management support, and security services using software as a service (SaaS). That is, the personnel evaluation management server 150 may provide a chat and schedule management function, a GPS-based attendance management, and an electronic approval function to the manager through the collaboration tool. In addition, when the project is completed, the personnel evaluation management server 150 may provide a function for the managers participating in the project, which are made by immediately evaluating the managers from each other through the personnel evaluation management service. In addition, the personnel evaluation management server 150 may provide information related to personnel evaluation by analyzing data according to the personnel evaluation result using the insight provision service.

According to the personnel evaluation management system 100, the manager 111 or the operator 121 may input personal information of the manager after signing up for membership through the application provided by the personnel evaluation management server 150. Thereafter, the manager 111 or the operator 121 may access the application by inputting a company code, an ID, a password, and the like,

The personnel evaluation management server 150 may provide a function of the collaboration tool and personnel evaluation and the insight provision service associated with the collaboration tool through the application. The personnel evaluation management server 150 may provide functions such as project management, chat management, video conference management, schedule management, data room management, and external office connection, using the collaboration tool. In particular, the personnel evaluation management server 150 may provide various functions for project collaboration, such as GPS-based attendance management and electronic approval, using the collaboration tool. In addition, the personnel evaluation management server 150 may provide a security function for a case where important files are leaked.

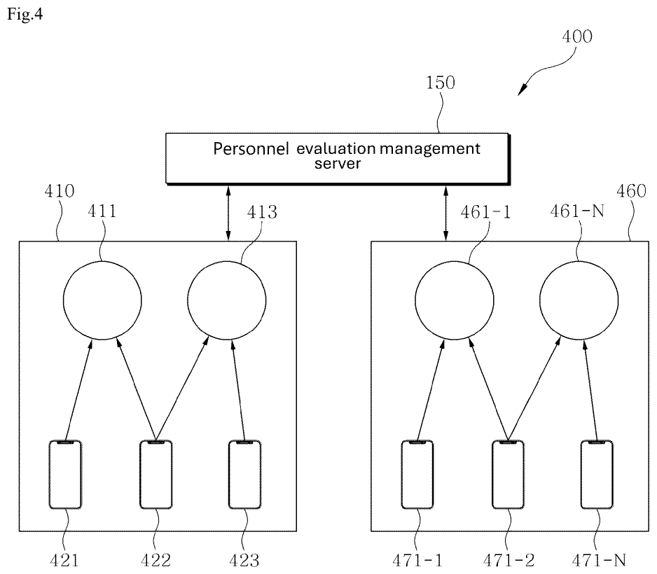

The personnel evaluation management server 150 may provide a personnel evaluation management function. A specific method of providing the personnel evaluation management service by the personnel evaluation management server 150 will be described in detail with reference to FIGS. 4 to 8. In addition, the personnel evaluation management server 150 may provide analysis information related to the organization and performance of the company using an insight provision tool.

FIG. 4 illustrates a relationship diagram 400 of the personnel evaluation management server 150, projects, and managers in the personnel evaluation management system 100 according to various embodiments of the present disclosure,

The personnel evaluation management server 150 may provide a personnel evaluation management function to a plurality of companies. According to one embodiment of the present disclosure, the personnel evaluation management server 150 may provide a personnel evaluation management service to a first company 410 and a second company 460. In this case, the second company 460 may indicate a company classified as the same industry as the first company 410. Although FIG. 4 illustrates a case where the number of companies associated with the personnel evaluation management server 150 is 2, the number of companies associated with the personnel evaluation management server 150 may be different.

Each of the companies may proceed with at least one project for the purpose of generating the profits of the company. A company may perform a plurality of projects sequentially or in duplicate. In this case, each manager may proceed with the project that the managers are in charge of. Referring to FIG. 4, the first company 410 may proceed with a first project 411 and a second project 413, a first task manager 421 and a second task manager 422 may be in charge of the first project 411, and a second task manager 422 and a third business manager 423 may be in charge of the second project 413. Similarly, the second company 460 may procced with a plurality of projects 461-1 to 461-N, and a plurality of operators 471-1 to 471-N may be arranged in each of the plurality of projects 461-1 to 461-N.

Referring to FIG. 4, the personnel evaluation management server 150 may manage personnel evaluation for the managers who perform projects for each of the companies. The personnel evaluation management server 150 may manage personnel evaluation for the first managers 421 and 422 in charge of the first project 411.

The personnel evaluation management server 510 receives a signal for requesting evaluation management for the first project 411 performed by the first company 410, At least one of the first managers 421 and 422 may request evaluation management of the first project 411 using a manager terminal operated by each person, and in response the request, the personnel evaluation management server 150 may receive an evaluation management request signal for the first project 411.

Thereafter, the personnel evaluation management server 150 may manage a first KPI list to be applied to the first managers 421 and 422 who participate in the first project 411. After the first project 411 is registered, the personnel evaluation management server 150 may determine a KPI list for evaluating the first managers 421 and 422 in charge of the first project 411.

In order to increase the reliability of evaluation, the personnel evaluation management server 150 may refer to a personnel evaluation and management method of the same industry according to a pre-stored industry classification table.

The personnel evaluation management server 150 may extract feature information for a plurality of projects performed by the same company based on the industry classification table. The feature information may indicate information including the scale, period, region, and difficulty level of the project as factors. In this case, the size may indicate an amount of funds of the project, the period may indicate a period from the start to the end of the project, the region may indicate a region unit in which the project is performed, and the difficulty level may indicate a difficulty level of the project evaluated by the operator,

Thereafter, the personnel evaluation management server 150 may extract comparison feature information having the highest similarity with the feature information for the project performed by a target company from among the feature information. The personnel evaluation management server 150 may extract primary feature information having the same region and difficulty level from among the feature information, may extract secondary feature information having a scale within a threshold scale difference from among the primary feature information, and may extract feature information having the smallest period difference from among the secondary feature information, as comparison feature information.

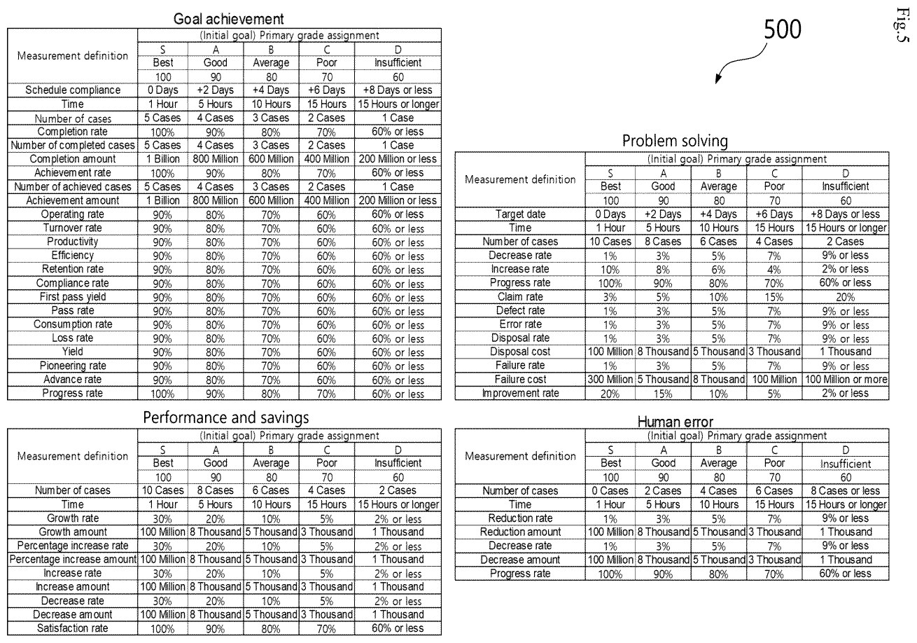

Thereafter, the personnel evaluation management server 150 may confirm a major job KPI applied to the comparison feature information and determine a KPI list so that KPI items included in the major job KPI are included. In this case, the major job KPI may indicate any one of goal achievement, growth and savings, problem solving, and human error. Examples of the KPI list classified into the major job KPI are illustrated in FIG. 5.

According to one embodiment of the present disclosure, when the industry of the first company 410 is a semiconductor equipment manufacturing industry, the personnel evaluation management server 150 may select the second company 460, which is one of the semiconductor equipment manufacturing industries. Thereafter, the personnel evaluation management server 150 may extract first feature information [100 million won, 12 months, Republic of Korea, High] from a first comparison project performed by the second company 460, and extract second feature information [50 million won, 6 months, Republic of Korea, High] from a second comparison project. Thereafter, the personnel evaluation management server 150 may extract target feature information [90 million won, 10 months, Republic of Korea, High] corresponding to the first project 411, and extract second feature information having a high similarity with the target feature information as comparison feature information. Thereafter, the personnel evaluation management server 150 may confirm goal achievement, which is a major job KPI applied to the second feature information, and determine a KPI list so that KPI items included in the goal achievement are included.

The personnel evaluation management server 150 may determine the KPI list, and may provide an evaluation page displaying the determined KPI list to the first managers 421 and 422 after the first project 411 is performed. The first managers 421 and 422 may perform evaluation on the performance of the first project 411 by confirming evaluation items for each other on the evaluation page. The personnel evaluation management server 150 may receive first evaluation result information indicating evaluation results for the managers which are made by the managers by evaluating the managers from each other.

The personnel evaluation management server 150 may synthesize the first evaluation result information to determine personnel evaluation scores corresponding to the first managers 421 and 422, respectively. In this case, the personnel evaluation management server 150 may determine a personnel evaluation score by additionally considering an important evaluation factor of the operator. In this case, the important evaluation factors may include a time factor, a performance factor, and an error factor. That is, the personnel evaluation management server 150 may determine a weight for KPI items from the importance for each factor related to the important evaluation factors, and determine the personnel evaluation score by applying the weight to the first evaluation result information.

According to one embodiment of the present disclosure, the personnel evaluation management server 150 may receive the importance for each factor of the important evaluation factors from the operator terminal. Thereafter, the personnel evaluation management server 150 may determine weights for the KPI items by using the importance for each factor. For example, when the importance for each factor is 3:4:3, the personnel evaluation management server 150 may classify the KPI items into the time factor, the performance factor, and the error factor, and may determine the weight as [1.3, 1.4, 1.3]. The personnel evaluation management server 150 may calculate a personnel evaluation score by applying the weight to the first evaluation result information that is a response result for the KPI items.

The personnel evaluation management server 150 may determine the personnel evaluation score in consideration of the task environment of a multi-manager who performs a plurality of projects in parallel. According to one embodiment of the present disclosure, the personnel evaluation management server 150 may receive the second evaluation result information indicating the evaluation results for the second managers 422 and 423 participating in the second project 413 performed by the first company 410, which are made by the second managers by evaluating from each other, and may extract a multi-manager 422 belonging to both the first managers 421 and 422 and the second managers 422 and 423. Thereafter, the personnel evaluation management server 150 may increase the importance of the time factor for the multi-manager 422 to update the importance for each factor applied to the multi-manager, and change the personnel evaluation score for the multi-manager 422 by considering the updated importance for each factor.

According to one embodiment of the present disclosure, when the importance for each factor is 3:4:3, the personnel evaluation management server 150 may change the importance for each factor for the multi-manager to 4:4:3. Accordingly, the personnel evaluation management server 150 may update the personnel evaluation score of the multi-manager 422 by determining the weight for each KPI item for the multi-manager 422 as [1.4, 1.4, 1.3].

The personnel evaluation management server 150 may provide feedback information to the manager performing the project in order to improve task efficiency after the project is performed. According to one embodiment of the present disclosure, the evaluation result information may include feedback information indicating an opinion for the second task manager 422 of the first task manager 421 in charge of the first project 411, and the personnel evaluation management server 150 may provide first feedback information to the second task manager 422 after determining the personnel evaluation score.

The personnel evaluation management server 150 may generate recommended task assignment information related to the personnel evaluation information in order to refer to future personnel assignment to the managers. That is, the personnel evaluation management server 150 may generate first analysis information indicating an effect that appears when a plurality of managers collaborate on one project and second analysis information indicating an effect that appears when one manager performs a plurality of projects simultaneously, and may generate recommended task assignment information for recommending task assignment in consideration of a relationship between the projects and the managers from the first analysis information.

According to one embodiment of the present disclosure, the personnel evaluation management server 150 may generate first analysis information indicating a change in task performance of the first task manager 421 and the second task manager 422 when the first task manager 421 and the second task manager 422 proceed with the first project 411 together, may generate second analysis information indicating a change in task performance of the first task manager 421 when the first task manager 421 proceeds with the first project 411 and the second project 413 simultaneously, and may generate recommended task assignment information of the first manager based on the first analysis information and the second analysis information, Thereafter, the personnel evaluation management server 150 may provide the recommended task assignment information to the operator.

FIG. 5 illustrates an example 500 of a major job KPI in the personnel evaluation management system 100 according to various embodiments of the present disclosure.

Referring to FIG. 5, the major job KPI may be classified as any one of goal achievement, growth and savings, problem solving, and human error. Although FIG. 5 illustrates a case where there are four major job KPIs, the major job KPIs may be changed according to the user's setting. Each major job KPI may include a plurality of KPI items, and each of the KPI items may be classified according to grade S, grade A, grade B, grade C, and grade D.

The personnel evaluation management server 150 may directly determine a KPI list to provide the KPI list to the manager, thereby providing a personnel evaluation management service, and may confirm the major job KPI applied to the comparison feature information in the process of determining the KPI list, and may determine the KPI list so that all KPI items included in the major job KPI are included. According to one embodiment of the present disclosure, the personnel evaluation management server 150 may determine a KPI list by adding a KPI item input by the operator to the KPI items included in the selected major job KPI. The managers may select a corresponding grade from the KPI items to input evaluation results for each other, and the personnel evaluation management server 150 may receive evaluation result information indicating the evaluation result to determine the personnel evaluation score.

In each of the KPI items, information which is a criterion for determining the evaluation may be changed according to the user's setting. That is, FIG. 5 illustrates a case where grade S is 0 days, grade A is +2 days, grade B is +4 days, grade C is +6 days, and grade D is +8 days in compliance with a predetermined rule, but the reference days corresponding to grade S to grade D may be different in the first company 410 and the second company 460.

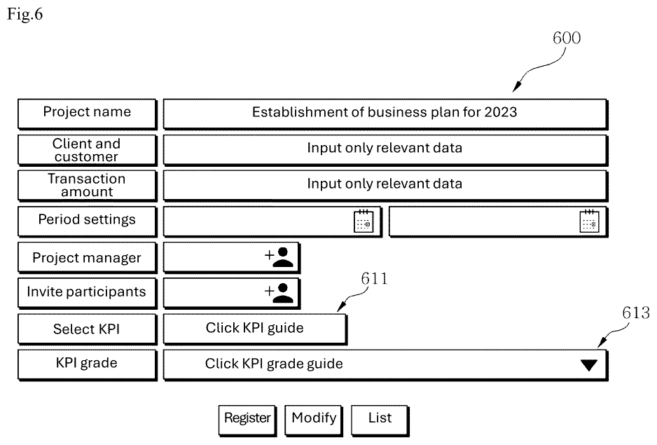

FIG. 6 illustrates an example 600 of a UI screen displayed on the manager terminal 110 when the manager 111 registers a project in the collaboration tool of the personnel evaluation management server 150 in the personnel evaluation management system 100 according to various embodiments of the present disclosure.

Referring to FIG. 6, when the manager 111 intends to newly register a project in the collaboration tool of the personnel evaluation management server 150, the manager terminal 110 may display a UI screen as illustrated in FIG. 6. The UI screen may display project name, client and customer, transaction amount, period settings, participant, project manager, and participant invitation item. In addition, for paid members or premium members, the UI screen may display KPI selection and KPI grade item.

The manager 111 may register the new project in the collaboration tool of the personnel evaluation management server 150 by inputting information related to the project according to the item displayed on the UI screen. In particular, the manager 111 may directly select the major job KPI by clicking or touching a KPI guide UI object 611 in a KPI selection table of contents and may select criteria for determining the KPI items by clicking or touching the KPI grade guide UI object 613 in a KPI grade table of contents.

According to one embodiment of the present disclosure, when the manager 111 clicks or touches the KPI guide UI object 611, a first selection pop-up window for selecting goal achievement, performance and savings, problem solving, and human error may be displayed on the UI screen. When the manager 111 selects the major job KPI in the first selection pop-up window, a second selection pop-up window in which KPI items corresponding to the major job KPI are displayed may be displayed. That is, the manager 111 may directly select the KPI item through sequential inputs on the first selection pop-up window and the second selection pop-up window. Thereafter, when the manager 111 clicks or touches the KPI grade guide UI object 613, a third selection pop-up window for inputting evaluation criteria for KPI items may be displayed. In the third selection pop-up window, the manager 111 may select reference values for determining grade S, grade A, grade B, grade C, and grade D for each KPI item.

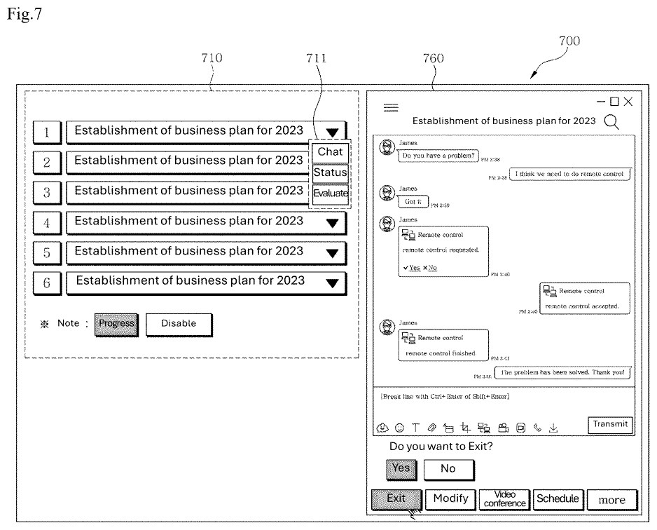

FIG. 7 illustrates an example 700 of a UI screen displayed on the manager terminal 110 in a process of performing the project using the collaboration tool by the manager 111 and starting a synchronized personnel evaluation management service in the personnel evaluation management system 100 according to various embodiments of the present disclosure.

When the project execution is completed, the personnel evaluation management server 150 may provide the manager with an evaluation page displaying the KPI list. Referring to FIG. 7, a first area 710 may display a project number and a project name, and a second area 760 may display a detailed operation screen according to an input of the first area 710. When the manager 111 clicks a status UI object in the first area 710, a status window 711 related to the project may be displayed. The status window 711 may display a chat item, a status item, an evaluation item, an exit item, and a modification item related to project execution. When the manager 111 touches or clicks a specific item, a detailed operation screen related to the specific item may be displayed in the second area 760.

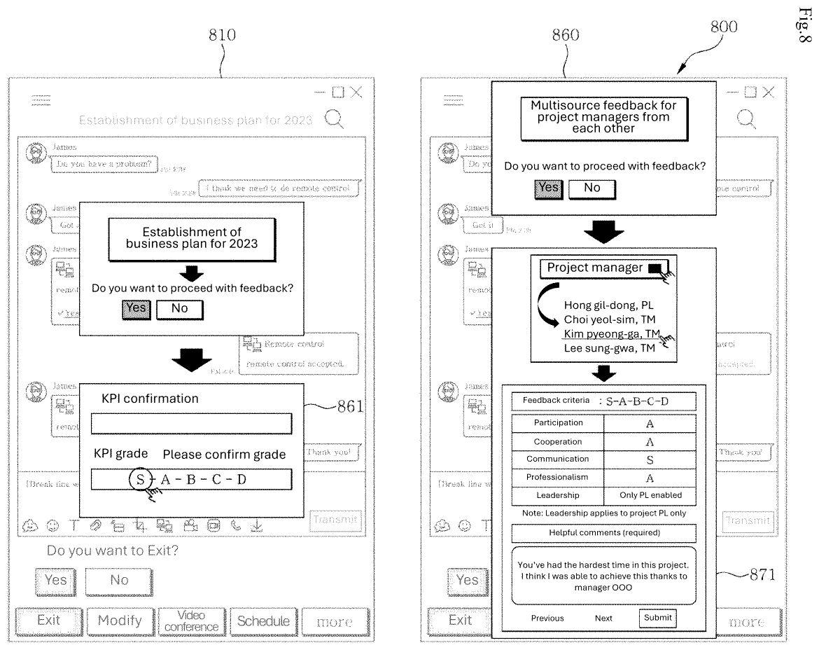

According to one embodiment of the present disclosure, when the manager 111 touches or clicks the project name in the first area 710, an additional pop-up window, which displays detailed information related to the project, such as a transaction amount, a period, a manager, and a participant list of the project, may be displayed. In addition, when the manager 111 clicks on a current status UI object, the status window 711 may pop up, and when the chat item is clicked on the status window 711, a chat screen may be displayed in the second area 760. In this case, when the manager 111 inputs the end of the project, a screen for KPI personnel evaluation may be displayed on the manager terminal 110. An example of the screen for personnel evaluation will be described in FIG. 8 in more detail.

FIG. 8 illustrates an example 800 of a UI screen displayed on the manager terminal 110 in a process of inputting personnel evaluation by the manager 111 in the personnel evaluation management system 100 according to various embodiments of the present disclosure.

Whenever the project is terminated, the personnel evaluation management server 150 may provide a synchronized personnel evaluation service for participants in the project. That is, the manager 111 may immediately input personnel evaluation for the project participants whenever the project is completed.

After the termination of the project is confirmed, the personnel evaluation management server 150 may control the screen for inputting personnel evaluation to be displayed on the manager terminal 110 in order to receive evaluation result information about the project. Referring to FIG. 8, a first UI screen 810 for inputting an evaluation result for a KPI item and a second UI screen 860 for inputting a feedback opinion may be simultaneously or sequentially displayed on the manager terminal 110.

The manager 111 may input a KPI item and a KPI grade corresponding to the KPI item through a pop-up window 861 in the first UI screen 860. That is, the manager 111 may select a KPI item and input an evaluation result for the corresponding KPI item in a range input for each grade, and the manager terminal 110 may generate evaluation result information based on the input of the manager. In addition, the manager 111 may input a feedback opinion for an evaluation subject through a pop-up window 871 in the first UI screen 860. The manager terminal 110 may generate feedback information based on an input of the manager.

The personnel evaluation management server 150 may receive the evaluation result information and the feedback information from the manager terminal 110, and may determine a personnel evaluation score by using the received information.

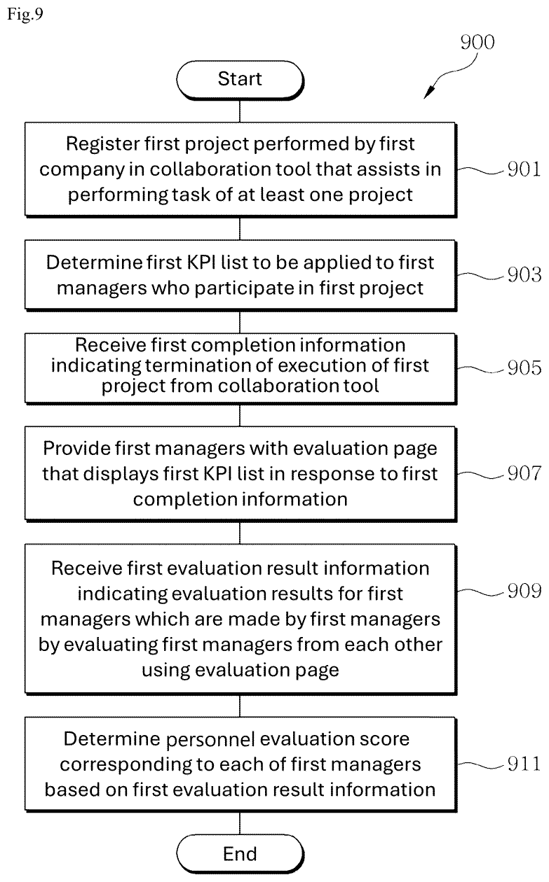

FIG. 9 illustrates a flowchart 900 of a method for operating the personnel evaluation management server 150 in the personnel evaluation management system 100 according to various embodiments of the present disclosure. FIG. 9 illustrates a method for operating the processor 220 that manages personnel evaluation using the personnel evaluation service associated with the collaboration tool.

Referring to FIG. 9, in step 901, the personnel evaluation management server 150 registers a first project performed by the first company in the collaboration tool that assists in performing task of at least one project. The personnel evaluation management server 150 may register a new project in the collaboration tool.

In step 903, the personnel evaluation management server 150 determines a first KPI list to be applied to the first managers who participate in the first project. The personnel evaluation management server 150 may assign the KPI in consideration of characteristics of the first managers.

According to one embodiment of the present disclosure, the personnel evaluation management server 150 may select a second company classified as the same industry as the first company based on the pre-stored industry classification table, may extract feature information corresponding to each of the plurality of projects performed by the second company and including a scale, a period, a region, and a difficulty level of each of the plurality of projects as factors, may extract comparison feature information from among the feature information based on target feature information corresponding to the first project, may determine a major job KPI applied to the comparison feature information, and may determine a KPI list so that KPI items included in the major job KPI are included. In this case, the major job KPI may indicate any one of goal achievement, growth and savings, problem solving, and human error.

In step 905, the personnel evaluation management server 150 receives first completion information indicating the termination of the first project from the collaboration tool. The manager may input the completion of the project to the collaboration tool, and the personnel evaluation management server 150 may confirm the termination of the project through the collaboration tool.

In step 907, the personnel evaluation management server 150 provides the first managers with an evaluation page that displays a first KPI list in response to the reception of the first completion information. The personnel evaluation management server 150 may provide the managers who participate in the first project with KPI evaluation items included in the first KPI list.

In step 909, the personnel evaluation management server 150 receives first evaluation result information indicating evaluation results for the first managers which are made by the first managers by evaluating from each other using the evaluation page. The manager 111 may input an evaluation result related to the performance contribution of the first project by using the evaluation page displayed on the manager terminal 110, and the personnel evaluation management server 150 may receive the evaluation result information from the manager terminal 110.

In step 911, the personnel evaluation management server 150 determines a personnel evaluation score corresponding to each of the first managers based on the first evaluation result information.

According to one embodiment of the present disclosure, the personnel evaluation management server may receive the importance of each factor of important evaluation factors for the first project, determine a weight for each of the KPI items based on the importance for each factor, and determine the personnel evaluation score by applying the weight to the first evaluation result information. In this case, the important evaluation factors may include a time factor, a performance factor, and an error factor.

According to one embodiment of the present disclosure, the personnel evaluation management server 150 determines a second KPI list to be applied to second managers who participate in a second project performed by the first company and registered in the collaboration tool, receives second completion information indicating the end of the second project from the collaboration tool, and provides the second managers with an evaluation page that displays the second KPI list to in response to the reception of the second completion information.

The personnel evaluation management server 2 may receive second evaluation result information indicating evaluation results for the second managers participating in the second project, which are made by the second managers by evaluating the second managers from each other. In this case, the execution period of the first project and the execution period of the second project may at least partially overlap each other.

According to one embodiment of the present disclosure, the personnel evaluation management server 150 may extract a multi-manager belonging to both the first managers and the second managers, may increase the importance of the time factor for the multi-manager, may update the importance for each factor applied to the multi-manager, and may change the personnel evaluation score for the multi-manager based on the updated importance for each factor.

According to one embodiment of the present disclosure, the first evaluation result information may include feedback information indicating an opinion for a second task manager of the first task manager from among the first managers, and the personnel evaluation management server 150 may provide the feedback information to the second task manager.

According to one embodiment of the present disclosure, the personnel evaluation management server 150 may generate first analysis information indicating a change in task performance of the first task manager and the second task manager when the first task manager and the second task manager proceed with the first project together, may generate second analysis information indicating a change in task performance of the first task manager when the first task manager proceeds with the first project and the second project simultaneously, may generate recommended task assignment information of the first manager based on the first analysis information and the second analysis information, and may provide the operator with the recommended task assignment information.

The methods according to the embodiments described in the claims or the specification of the present disclosure may be implemented in hardware, software, or a combination of hardware and software.

When the methods are implemented in software, a computer-readable storage medium storing one or more programs (software modules) may be provided. The one or more programs stored in the computer-readable storage medium are configured for execution by one or more processors in an electronic device. The one or more programs include instructions that cause the electronic device to execute the methods according to the embodiments described in the claims or specification of the present disclosure.

The program (software module or software) may be stored in a random access memory, a non-volatile memory including a flash memory, a read only memory (ROM), an electrically erasable programmable read only memory (EEPROM), a magnetic disk storage device, a compact disc-ROM (CD-ROM), digital versatile discs (DVDs) or other types of optical storage devices, or a magnetic cassette. Alternatively, the program may be stored in a memory composed of a combination of some or all of them. In addition, a plurality of constituent memories may be included.

In addition, the program may be stored in an attachable storage device that may access the electronic device through a communication network such as the Internet, an intranet, a local area network (LAN), a wide area network (WAN), or a storage area network (SAN), or a communication network configured by a combination thereof. The storage device may access a device performing the embodiment of the present disclosure through an external port. In addition, a separate storage device on the communication network may access a device performing the embodiment of the present disclosure.

In the above-described specific embodiments of the present disclosure, the components included in the present disclosure are expressed in the singular or the plural according to the presented specific embodiments. However, the singular or the plurality of expressions are appropriately selected for the situation presented for convenience of description, and the present disclosure is not limited to the singular or the plurality of components, and even the components expressed in the plural may be configured in the singular, or even the components expressed in the singular may be configured in the plural.

Meanwhile, in the detailed description of the present disclosure, specific embodiments have been described, but various modifications are possible without departing from the scope of the present disclosure. Therefore, the scope of the present disclosure should not be limited to the described embodiments, but should be determined not only by the scope of the claims to be described below, but also by those equivalent to the scope of the claims.

1. A method for operating a personnel evaluation management server that assigns key performance indicators (KPIs) for a manager and manages personnel evaluation by using a personnel evaluation service associated with a collaboration tool, the method comprising:
registering a first project in a collaboration tool that provides chat, video conference, schedule management, office management support, and security services based on an input of a manager participating in the first project performed by a first company;
determining a first KPI list to be applied to first managers participating in the first project;
providing the first managers with a collaboration tool UI screen that displays a first area related to a project number and a project name of the first project and a second area related to detailed contents according to an input of the first area;
receiving first completion information indicating termination of execution of the first project through the collaboration tool UI screen;
providing the first managers with an evaluation page that displays the first KPI list in response to reception of the first completion information;
receiving first evaluation result information indicating evaluation results for the first managers which are made by the first managers by evaluating the first managers from each other using the evaluation page;
determining a personnel evaluation score corresponding to each of the first managers based on the first evaluation result information;
generating first analysis information indicating a change in task performance abilities of a first task manager and a second task manager when the first task manager and the second task manager among the first managers proceed with the first project together;
generating second analysis information indicating a change in a task performance ability of the first task manager when the first task manager proceeds with the first project and a second project simultaneously;
generating recommended task assignment information of the first manager based on the first analysis information and the second analysis information; and
providing an operator with the personnel evaluation score and the recommended task assignment information,
wherein the determining of the KPI list includes:
selecting a second company classified as the same industry as the first company based on a pre-stored industry classification table;
extracting feature information including factors such as a scale, a period, a region, and a difficulty level of each of a plurality of projects and corresponding to each of the plurality of projects performed by the second company, and target feature information corresponding to the first project;
extracting comparison feature information from among the feature information, in which the comparison feature information coincides with the target feature information in terms of the region and the difficulty level, has a scale within a threshold scale difference, and has a smallest period difference; and
determining a KPI list by adding a KPI item, which is input by an operator who confirms a progress situation of the first project and manages the personnel evaluation, to KPI items included in a major job KPI applied to the comparison feature information,
wherein the determining of the personnel evaluation score includes:
receiving an importance for each factor of the important evaluation factors for the first project;
determining weights for each of the KPI items based on the importance for each factor; and
determining the personnel evaluation score by applying the weights to the first evaluation result information,
wherein the major job KPI indicates any one of goal achievement, growth and savings, problem solving, and human error,
wherein the important evaluation factors include a time factor, an achievement factor, and an error factor, and
wherein the collaboration tool UI screen includes a screen for displaying a chat screen in the second area when the manager selects a chat item through the first area and receiving an input of termination of the first project from the manager through the chat screen.

2. The method of claim 1, further comprising:
determining a second KPI list to be applied to second managers who participate in the second project that is performed by the first company and registered in the collaboration tool;
receiving second completion information indicating termination of execution of the second project through the collaboration tool;
providing the second managers with an evaluation page that displays the second KPI list in response to reception of the second completion information;
receiving second evaluation result information indicating evaluation results for the second managers participating in the second project, which are made by the second managers by evaluating the second managers from each other;
extracting a multi-manager belonging to both the first managers and the second managers;
updating an importance for each factor applied to the multi-manager by increasing an importance of the time factor for the multi-manager; and
changing a personnel evaluation score for the multi-manager based on the updated importance for each factor, and
wherein an execution period of the first project and an execution period of the second project at least partially overlap each other.

3. The method of claim 1, wherein the first evaluation result information includes feedback information indicating an opinion for the second task manager of the first task managers, and
the method further comprises providing the second task manager with the feedback information.

4. The method of claim 1, further comprising:
storing an IP address for an account where a file shared through the chat screen has been downloaded; and
tracking a file sharer by using the IP address when it is determined that a file having a safety problem is shared.
